(19) United States
(12) Patent Application Publication
(10) Pub. No.: US 2026/0170497 A1
(43) Pub. Date: Jun. 18, 2026

(54) SYSTEM AND METHOD FOR PROVIDING AN ATTESTATION VIA A PROXY SERVER

(71) Applicant: AT&T Intellectual Property I, L.P., Atlanta, GA (US)

(72) Inventors: Eric Zavesky, Austin, TX (US); Ginger Chien, Bellevue, WA (US); Zhi Cui, Sugar Hill, GA (US)

(21) Appl. No.: 18/985,005

(22) Filed: Dec. 17, 2024

(51) Int. Cl. G06Q 20/40; H04L 9/32

(52) U.S. Cl. CPC G06Q 20/401; H04L 9/32

(57) ABSTRACT

Method, computer-readable media, and apparatuses for providing an attestation for a transaction performed by a proxy application are described. For example, a processing system including at least one processor may establish a communication session between at least a first endpoint device of a first user and at least one third party application server via at least one communication network, detect at least one proxy initiated transaction for the first endpoint device requiring an attestation, forward an attestation request to a designated entity responsive to the at least one proxy initiated transaction being detected, and receive the attestation from the designated entity.

The present disclosure relates generally to providing attestations via a proxy server, such as vouching for transactions carried out by proxy applications, or the like, and more particularly to methods, non-transitory computer-readable media, and apparatuses for providing an attestation for a transaction performed by a proxy application, e.g., a digital assistant application.

### SUMMARY

Devices, non-transitory computer-readable media, and methods for providing an attestation for a transaction performed by a proxy application are disclosed. An example method includes establishing a communication session between at least a first endpoint device of a first user and at least one third party application server via at least one communication network, detecting at least one proxy initiated transaction for the first endpoint device requiring an attestation, forwarding an attestation request to a designated entity responsive to the at least one proxy initiated transaction being detected, and receiving the attestation from the designated entity.

In another example, a non-transitory computer-readable medium stores instructions which, when executed by a processing system including at least one processor, cause the processing system to perform operations. The operations include establishing a communication session between at least a first endpoint device of a first user and at least one third party application server via at least one communication network, detecting at least one proxy initiated transaction for the first endpoint device requiring an attestation, forwarding an attestation request to a designated entity responsive to the at least one proxy initiated transaction being detected, and receiving the attestation from the designated entity.

In another example, a device includes a processing system including at least one processor and a non-transitory computer-readable medium. The non-transitory computer-readable medium stores instructions which, when executed by the processing system, cause the processing system to perform operations. The operations include establishing a communication session between at least a first endpoint device of a first user and at least one third party application server via at least one communication network, detecting at least one proxy initiated transaction for the first endpoint device requiring an attestation, forwarding an attestation request to a designated entity responsive to the at least one proxy initiated transaction being detected, and receiving the attestation from the designated entity.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates an example user interface for providing an attestation for a transaction performed by a proxy application via a proxy server, in accordance with the present disclosure;

FIG. 3 illustrates a flowchart of an example method for providing an attestation for a transaction performed by a proxy application via a proxy server, in accordance with the present disclosure; and

FIG. 4 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

In one example, the present disclosure describes a method, non-transitory computer-readable medium, and apparatus for providing an attestation for a transaction performed by a proxy application via a proxy server. For instance, in one example, a processing system including at least one processor (e.g., a proxy server) may establish a communication session between at least a first user endpoint device of a first user and at least one application server of a third party service provider via at least one network. The processing system may then detect at least one proxy initiated transaction for the first user endpoint device that requires an attestation (e.g., a vouching confirmation or approval) from another entity (e.g., a designated person, a designated system, or even the first user of the first user endpoint device), e.g., via at least one transaction detection model, and forwarding an attestation request to a designated endpoint device responsive to the detected at least one proxy initiated transaction.

With the proliferation of artificial intelligence (AI) technology, proxy applications such as digital assistant applications have evolved with ever increasing transaction capabilities. When such digital assistant applications are utilized by responsible adults, these smart proxy applications have greatly increased the efficiency of performing transactions on behalf of people who may have to otherwise commit a substantial amount of time to perform mundane manual transactions on their own. For example, a digital assistant application may be tasked with: 1) searching for a gift for a grandchild as requested by a grandparent, 2) searching for an alternative route to avoid an accident as requested by a driver, 3) paying utility bills on a monthly basis as requested by an account holder, 4) posting updates to a social media channel or social media wall as requested by a social media account holder, 5) scheduling a child sitting service for a spousal night outing as requested by a parent, and so on. The multitude of tasks that can be offloaded to such proxy applications can create great efficiency but also incur significant challenges when utilized by minors or the elderly. Namely, minors and/or the elderly may utilize such proxy applications on widely available endpoint devices to conduct a multitude of transactions, where some transactions are quite benign (e.g., scheduling a play date, acquiring researcher articles for self-improvement, etc.), while other transactions (e.g., buying a vehicle online, buying restricted drugs online, posting inflammatory comments on a social media channel or wall, providing very personal information to a suspicious website, etc.) may call into question as to the user's judgement or inattentiveness to the actions taken by the proxy application. Thus, with the proliferation of potent proxy applications, a dilemma or tension is now realized where the efficiency of such proxy applications must be properly balanced with the vulnerability created by such proxy applications, especially as applied to minors, the elderly and/or even inattentive adults.

Furthermore, in one example, even responsible adults may also be caught off guard by the efficiency of such proxy applications due to their busy schedules and/or lack of attentiveness to current events. For example, a proxy application tasked with paying a utility bill may not account for unexpected events such as an unexpected weather phenomenon that causes a utility bill to skyrocket beyond a reasonable expectation (which may require a negotiation to take place with the utility company before the bill is paid). In another example, a proxy application tasked with posting current events of a user may not account for unexpected events such as a need to travel extensively out of state for medical treatments that may reveal too much personal information, e.g., letting people know that the user's house will not be occupied for an extended period of time, and so on. In another example, a proxy application may make a payment or take an action that may constitute a legal agreement or legal admission (e.g., payment of the penalty for a parking ticket, a speeding ticket, and the like) that may bring about legal consequences.

In particular, examples of the present disclosure may utilize real-time network-hosted artificial intelligence (AI)/machine learning (ML) to detect at least one proxy initiated transaction for the first user endpoint device that requires an attestation (e.g., a vouching confirmation or approval) from another designated entity (e.g., a designated person or a designated system). Examples of the present disclosure may comprise a network-managed AI/ML module that determines contextual relevance associated with the purpose of the at least one proxy initiated transaction. To illustrate, an AI/ML module of the present disclosure may pull relevant context information from a profile of the user who initiated the at least one proxy initiated transaction, a rule set associated with the user associated with receiving proxy triggered attestations, the historical behaviors of the user, the historical behaviors of the designated user who is tasked with providing the attestations for the user, and/or current events that may have triggered the proxy initiated transaction (e.g., detecting a recent natural disaster that the user is trying to make a charitable donation to help victims of the natural disaster, and so on), to identify the need for an attestation for a proxy initiated transaction.

In one embodiment, the detection of the at least one proxy initiated transaction includes detecting whether an attestation is required. For example, a proxy initiated transaction that schedules a doctor's appointment for a yearly physical examination may not require an attestation, whereas a proxy initiated transaction that schedules a delivery of a restricted product (e.g., alcohol, certain drugs, munitions, etc.) purchased across state lines may require an attestation. In one embodiment, the network-hosted artificial intelligence (AI)/machine learning (ML) is also provided with a pertinent customized rule set for a particular user to further allow the network-hosted artificial intelligence (AI)/machine learning (ML) to distinguish transactions that require proxy triggered attestations from those transactions that do not. For example, the rule set for a first user may require all out of state purchases conducted by the proxy application to be verified via attestations, whereas the rule set for a second user may require all purchases above $300 conducted by the proxy application to be verified via attestations. In another example, the rule set for a third user may require all account transfers between a multitude of financial institutions conducted by the proxy application to be verified via attestations, whereas the rule set for a fourth user may only require account transfers greater than $500 between a multitude of financial institutions conducted by the proxy application to be verified via attestations. In yet another example, the rule set for a fifth user may require all social media postings by a sixth user (e.g., a minor) to be verified via attestations, whereas the rule set for a seventh user may only require social media postings discussing “controversial” topics by an eighth user (e.g., an elderly) to be verified via attestations. In one embodiment, the seventh user may list topics deemed to be controversial or the network-hosted artificial intelligence (AI)/machine learning (ML) is able to ascertain topics that are currently deemed to be controversial on behalf of the seventh user, e.g., crawling over various news websites and/or discussion forums.

By detecting proxy initiated transactions and then requesting the necessary attestations from a designated entity, the present disclosure will provide the necessary warnings or check points to users, such that the users can be spared of potentially embarrassing scenarios or consequences of unintended actions taken by the proxy applications. For example, an elderly may instruct a proxy application to locate and purchase a car online, but the family of the elderly may strongly disagree with this action since the elderly may have cognitive issues that would prohibit the elderly from driving. The proxy application would be able to easily achieve the requested transaction. However, in this example, the present disclosure may detect the proxy initiated transaction from the endpoint device of the elderly via the network-hosted proxy server and may determine that this proxy initiated transaction would require an attestation (or a vouching confirmation or approval) to be received from a designated entity before the proxy initiated transaction is authorized to be completed. For instance, any proxy initiated transaction associated with this elderly that involves purchases greater than $100 will require an attestation to be received before the transaction can be allowed to proceed.

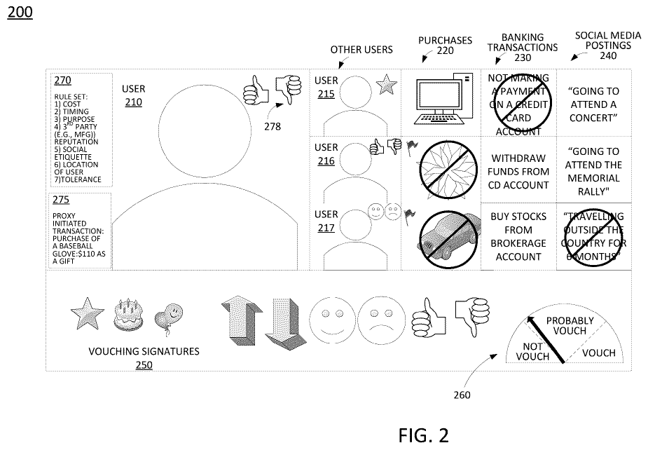

In one example, an AI/ML module may identify the degree (e.g., how far or how close) the proxy initiated transaction would likely receive the necessary attestation from the designated entity. In other words, the endpoint device of the designated entity may receive the request to provide the attestation for the proxy initiated transaction, but the AI/ML module deployed in the network or on the endpoint device of the designated entity may analyze the proxy initiated transaction and provides a recommendation as to whether the attestation should be provided or given. Namely, the decision to provide the attestation may not be easily ascertained by the designated entity if the relevant rule set pertaining to the elderly is fairly complicated (e.g., having a large set of criteria). Furthermore, the designated entity may be responsible for a plurality of individuals who rely on the designated entity to provide attestations for all their proxy initiated transactions, thereby straining the designated entity's ability to recall the pertinent rule set to be applied for the pertinent user, e.g., such as the director of a nursing home tasked with being the designated entity for all the residents of the nursing home. This responsibility may impart a significant amount of work on the designated entity to apply the proper pertinent rule set to the pertinent proxy initiated transaction associated with the pertinent user. In such an example, the recommendation may indicate the degree (e.g., “yes,” “likely yes,” “likely no,” or “no”) that the proxy initiated transaction of the user should receive the attestation. In one example, the recommendation may include a visualization, such as a dial/meter (e.g., 260 of FIG. 2) that indicates the degree that the proxy initiated transaction of the user should receive the attestation (e.g., “not vouch,” “probably vouch,” “vouch,” or the like).

Notably, the proxy initiated transactions are growing as the norm for providing digital assistances. Examples of the present disclosure enhance a network-hosted or network-based service (e.g., an opt-in service) that will serve to monitor and control proxy initiated transactions to protect the users from unknowingly and/or unintentionally performing transactions that they themselves triggered by using the potent proxy applications on their endpoint devices.

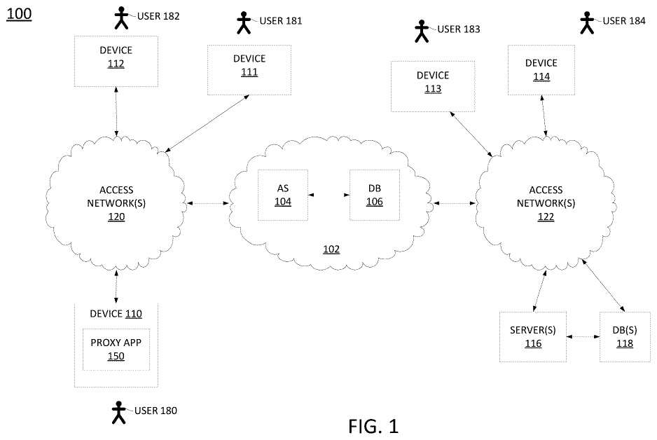

In one example, the present disclosure may include a user interface 200 of FIG. 2 to inform/communicate with a user/designated entity regarding a request for an attestation (a vouching confirmation or approval) for a proxy initiated transaction. In one example, the present disclosure may coordinate with one or more devices of each user to be monitored with the designated entity to provide the most effective communication. For example, a group communication devices (e.g., a user tablet, a user, laptop, a user computer, a user smart phone, a network-hosted proxy server, a network-hosted application server, or the like) may monitor proxy initiated transactions, user device locations, the type(s) of available devices/hardware, supported input-output technologies, and so forth. In one example, the present disclosure may select from among an ecosystem of devices for a user to be monitored and/or a designated entity and for a given communication session such that the user's proxy initiated transaction is best served. In addition, in one example, the present disclosure may learn when it is appropriate to communicate specific types of status to specific users and/or designated entities, e.g., reporting back to the user who is being monitored that his or her proxy initiated transaction has been approved or denied by the designated entity (e.g., an elderly who has cognitive or memory issues may not be informed that his or her proxy initiated transaction has been denied due to failing to obtain the necessary attestation from the designated entity), or the like. For instance, the present disclosure may select from among multiple communication modalities to communicate discretely with one or more users regarding when the users' proxy initiated transactions are vouched or not vouched for, and so forth. These and other aspects of the present disclosure are described in greater detail below in connection with the examples of FIGS. 1-4.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G and the like), a long term evolution (LTE) network, and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a core network of a communication network service provider (e.g., a telecommunication network). The network 102 may be in communication with one or more access networks 120 and 122, and the Internet (not shown). In one example, network 102 may combine core network components of a cellular network with components of a triple play service network; where triple-play services include telephone services, Internet services, and video services to subscribers or other users. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a broadcast video network, e.g., a cable television provider network or an Internet Protocol Television (IPTV) network, as well as an Internet Service Provider (ISP) network. In one example, network 102 may include a plurality of video or television (TV) servers (e.g., a broadcast server, a cable head-end), a plurality of content servers, an advertising server (AS), an interactive TV/video-on-demand (VoD) server, and so forth. For ease of illustration, various additional elements of network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a communication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like. In one example, each of access networks 120 and 122 may include at least one access point, such as a cellular base station, non-cellular wireless access point, a digital subscriber line access multiplexer (DSLAM), a cross-connect box, a serving area interface (SAI), a video-ready access device (VRAD), or the like, for communication with various endpoint devices.

In one example, the access networks 120 may be in communication with one or more devices 110-112. Similarly, access networks 122 may be in communication with one or more devices, e.g., devices 113 and 114, server(s) 116, databases (DBs) 118, and so forth. Access networks 120 and 122 may transmit and receive communications between devices 110-114, server(s) 116 and/or database (DB) 118, application server (AS) 104 and/or database (DB) 106, other components of network 102, devices reachable via the Internet in general, and so forth.

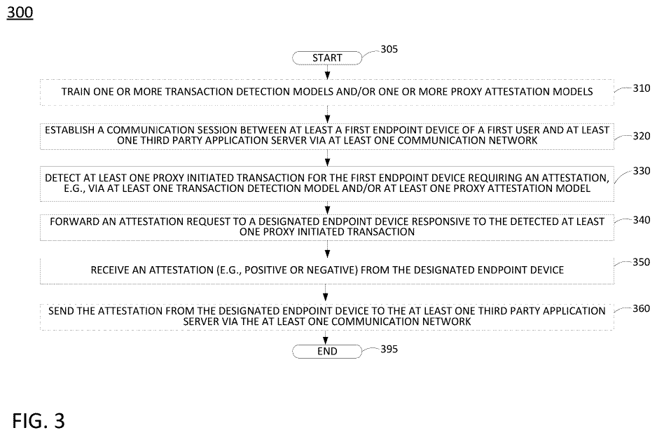

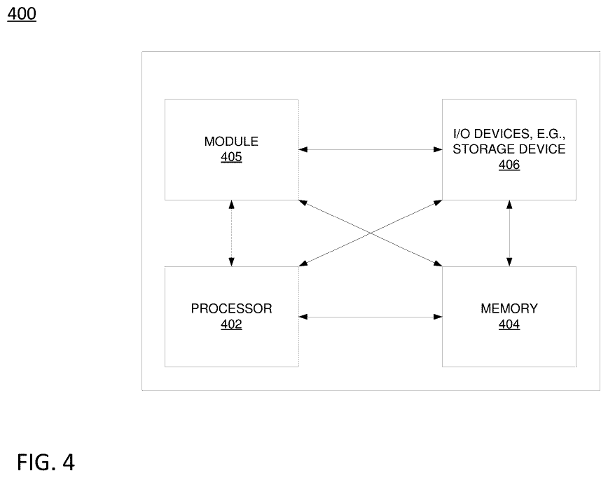

In one example, each of the devices 110-114 may comprise any single device or combination of devices that may comprise a user endpoint device. For example, the devices 110-114 may each comprise a mobile computing device, e.g., a cellular smart phone, a laptop, a tablet computer, a wearable computing device (e.g., a smart watch, a smart pair of eyeglasses, etc.), an augmented reality (AR) or virtual reality (VR) endpoint device, a desktop computer, an application server, a bank or cluster of such devices, and the like. In one example each of devices 110-114 may include a microphone and speaker, and may further include a display, a touch screen and/or keyboard, and so forth. In accordance with the present disclosure, each of the devices 110-114 may comprise a computing system or server, such as computing system 400 depicted in FIG. 4, and may be configured to perform operations or functions in connection with examples of the present disclosure for providing an attestation for a transaction performed by a proxy application (such as illustrated and described in connection with the example method 300 of FIG. 3). For instance, each of the devices 110-114 may establish communication with server(s) 116 and/or application server 104 to participate in a communication session for providing an attestation for a transaction performed by a proxy application. In one example, any of the devices 110-114 may include a proxy application (app) that is capable of supporting a method for providing an attestation for a transaction performed by a proxy application. In one example, such an app may comprise or may include a virtual assistant application that may alert respective users 180-184 of the need for providing an attestation for a transaction performed or initiated by a proxy application, which may be determined by the app on the respective one of the devices 110-114 or which may be determined by a proxy server (e.g., application server(s) 104 and/or 116) or another network-based entity participating in the communication session.

In one example, the access networks 122 may also be in communication with server(s) 116 and DB(s) 118. In accordance with the present disclosure, each of the server(s) 116 may comprise a computing system or server, such as computing system 400 depicted in FIG. 4, and may individually or collectively be configured to perform operations or functions for providing an attestation for a transaction performed by a proxy application (such as illustrated and described in connection with the example method 300 of FIG. 3). For instance, server(s) 116 may host and may represent one or more third party service provider platforms/services, or the like. For instance, each of the devices 110-114 may communicate with server(s) 116 to establish a communication session to access a service provided by server(s) 116, e.g., server(s) 116 may host a website for a retailer for selling products and services, a website of a financial institution (e.g., a bank or a brokerage firm) for conducting financial transactions, a website of a social media platform for allowing subscribers to make postings, and the like.

To illustrate, server(s) 116 may receive requests (e.g., proxy application initiated transaction requests) from the devices (e.g., devices 110-114 of users 180-184) comprising at least transaction for at least one service or product. Server(s) 116 may also maintain user accounts and perform device and/or user authentication and authorization, may provide different levels of access to different users or designated entities based on user profiles/accounts, permissions set by hosts/organizers, etc.

In one example, application server(s) 104 may comprise a proxy server that may operate as an intermediary for detecting and managing a proxy initiated transaction that may originate from one of the devices 110-114 of one of corresponding users 180-184. For instance, server(s) 104 may comprise a proxy server that employs an AI/ML module for detecting and analyzing a proxy initiated transaction and for determining whether an attestation is required from a designated entity. For example, a user 180 (an elderly) may utilize or direct a proxy application on user endpoint device 110 to search for a gift for a grandchild. In turn, agent tool interfaces (e.g., application programming interfaces (APIs), webhooks, or the like) of the proxy application my call/interact with various tools or applications on the endpoint device 110 and/or server 116 to initiate the search for the gift for the grandchild. For example, proxy application 150 in endpoint device 110 may access a contact list of user 180 to ascertain the information of the grandchild, e.g., the identity of the grandchild, the age of the grandchild, the gender of the grandchild, the address of the grandchild, and so on. In turn, the proxy application 150 in endpoint device 110 may also access a texting application or email application of user 180 to ascertain the most recent correspondences between user 180 and the grandchild, e.g., to discover communication content relating to interests of the grandchild, gift preferences of the grandchild, and so on. In turn, based on the discovered identity of the grandchild (e.g., a 10 year old boy) and the potential interest (e.g., baseball) of the grandchild, the proxy application 150 in endpoint device 110 may also access a browser application on endpoint device 110 to conduct a search for baseball related gifts (e.g., a baseball glove, a baseball bat, a child-sized baseball jersey of a favorite baseball player of the grandchild, available baseball game tickets for a baseball team playing in an area local to the address of the grandchild, and so on). The proxy application 150 may also be given a cost range that user 180 is willing to spend on the gift for the grandchild, e.g., $100-$150. Once the proxy application 150 has located the availability of a potential gift, e.g., a baseball glove costing $110, via a retailer website hosted on server 116, the proxy application 150 may inform user 180 as to its search result and/or may seek approval from the user 180 in order to execute the transaction of purchasing the baseball glove costing $110 from the retailer. If approval is received from user 180 (or not deemed necessary by the proxy application 150 given its authority settings to perform certain tasks automatically), the proxy application 150 may access the credit card account information of user 180 to effect the purchasing of the baseball glove by providing the credit card account information to the retailer for the amount of $110.

Although the above example illustrates the efficiency of the functions performed by the proxy application 150, it also reveals significant challenges if the proxy initiated transaction is executed without further confirmations from a designated entity For example, the proxy initiated transaction may have been triggered by a child gaining access to a parent's endpoint device, the proxy initiated transaction may have been authorized erroneously by an elderly for the cost range of $10,000-$15,000 instead of $100-$150, and so on.

In one embodiment of the present disclosure, a proxy server (e.g., application server 104) may monitor the proxy initiated transaction on a communication session between endpoint device 110 and server 116. The proxy server is tasked with deciding whether an attestation is required for the transaction performed by the proxy application. If the attestation is required for the transaction, proxy server will interrupt (e.g., suspend or pause) the transaction being conducted between proxy application 150 on the endpoint device and the retailer website hosted on server 116, e.g., by sending an instruction the endpoint device 110 and/or server 116 to pause the transaction until an attestation can be acquired to authorize the completion of the proxy initiated transaction. The instruction to the server 116 may further include information identifying the current suspended transaction is a proxy initiated transaction. This additional information may allow the retailer system to realize that the current transaction is a machine to machine transaction (e.g., without any human input), which may necessitate additional safeguards to be carried out. For example, proxy application 150 may be configured intentionally so that its proxy initiated transaction can be easily identified by proxy server 104 and/or server 116. In one example, the sign-in credentials presented by proxy application 150 will be different than the sign-in credentials presented by user 180 for the same account, e.g., a password presented by proxy application 150 will be “ABC,” whereas a password presented by user 180 will be “XYZ” where both passwords are allowed for the account. Based on the password presented, proxy server 104 and/or server 116 will be able to quickly distinguish between a proxy initiated transaction from that of a human user initiated transaction. Other identifying mechanisms can also be used, e.g., different encryption keys can be used, different sign-on user names, the proxy application 150 actively informing the retailer website hosted on server 116 of its identity, and so on. An aspect of the present disclosure is that the proxy application 150 is not attempting to disguise its identity and, in fact, is openly revealing its true nature to be discovered and monitored by proxy server 104 and/or server 116.

Finally, if the decision to provide the proxy attestation is needed, the proxy server 104 will suspend the proxy initiated transaction and send a proxy triggered attestation request (broadly an attestation request) to an endpoint device of a designated entity (e.g., a designated person or a designated system). For example, if user 180 is an elderly, the designated person may be user 181 or user 182 (e.g., children of user 180) via endpoint device 111 or 112, who will review the proxy initiated transaction and provide an attestation response (e.g., a vouching confirmation authorizing the proxy initiated transaction to proceed to completion or a vouching denial stopping the proxy initiated transaction from being completed). For example, if the proxy initiated transaction relates to a baseball related gift in the range of $100-$150, user 181 or 182 will provide the necessary attestation (e.g., a yes vouching response, but if the proxy initiated transaction relates to a baseball related gift in the range of $10,000-$15,000, user 181 or 182 will not provide the necessary attestation (e.g., a no vouching response)). In one embodiment, the designated endpoint device of the designated entity may be configured to generate the vouching confirmation (broadly a positive attestation) or vouching denial (broadly a negative attestation) automatically by setting the pertinent thresholds, e.g., “all purchases for user1 less than $100 will automatically receive a positive vouching,” “all purchases for user2 greater than $150 will automatically receive a negative vouching,” “all purchases for user3 made during the hours of 9:00 am-5:00 pm will automatically receive a positive vouching,” “all transactions attempting to open a financial account for user4 will automatically receive a negative vouching,” and the like. Thus, in one embodiment, the designated entity's endpoint device may automatically generate the necessary attestation (positive or negative) in response to the attestation request, thereby effecting a machine to machine transaction (e.g., without any human input in responding to the attestation request).

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, DB(s) 118 may comprise one or more physical storage devices integrated with server(s) 116 (e.g., a database server), attached or coupled to the server(s) 116, or remotely accessible to server(s) 116 to store various types of information in support of systems for providing an attestation for a transaction performed by a proxy application. For example, DB(s) 118 may include a user profile database that may store records (e.g., user profiles) for one or more users (e.g., users 180-184). It should be noted that, not all users who utilize proxy application 150 may desire to use the current monitoring and/or alerting service. However, for those participating users, each user profile may include user designated contacts (e.g., a designated entity list for providing the necessary attestations for proxy initiated transactions) and/or a user's relationships with such designated contacts (e.g., the user himself or herself, a parent, a child, a supervisor, a teacher, a doctor, a family member, a guardian, a director of an institution, and so forth). In one example, user profiles may also include designated entity and/or monitored user preferences (e.g., a rule set) for providing/receiving an attestation for a transaction performed by a proxy application. For example, the rule set may comprise one or more of: 1) the cost of the proxy initiated transaction, 2) the timing of the proxy initiated transaction, 3) the purpose of the proxy initiated transaction, 4) the third party reputation fulfilling the proxy initiated transaction (e.g., a socially responsible manufacturer using environmentally friendly material, a socially responsible manufacturer complying with all child labor laws, and the like), 5) the proxy initiated transaction complying with social norm or social etiquette (e.g., not posting controversial comments on a social media website), 6) the current location of the user when the proxy initiated transaction is triggered, e.g., is the user situated at home versus traveling abroad, and so on. In one example, the user profiles may also include user preferences for various different actions that may be deployed when the proxy initiated transaction is detected and an attestation is required, such as selective approving (only during day time between 9:00 am-8:00 pm), selective denying (only during night time between 10:00 pm-8:00 am), selective alerting (e.g., only greater than $500 when the user is outside of the country), as well as the method(s) of alerting (e.g., real time SMS messaging, emails, an automated phone call), and so forth. It should be noted that the user preferences can be from either of the monitored user or the designated entity (or from both). In other words, the designated entity may have a set of parameters that will be important to the designated entity in determining whether to provide a positive or a negative attestation request. Similarly, the user being monitored may also have a set of parameters that will be important to the user being monitored, e.g., a responsible adult may still want to be notified if his or her own proxy application is automatically conducting transactions on their behalf under certain scenarios, e.g., paying an unusually large credit card bill, and so on.

Thus, it should be noted that in one embodiment, the designated entity may very well be the user himself or herself. In other words, the user may want to be notified when the proxy application 150 is attempting to perform or complete a proxy initiated transaction. For example, the user may not be aware that the proxy application 150 is attempting to complete a proxy initiated transaction or the user may simply have forgotten that he or she has previously activated the proxy application 150 to perform the proxy initiated transaction.

In one example, the user profiles may further include user preferences for selectively relaxing one or more of the criteria of the rule set. For example, the rule set may have a rule that only grants the proxy application 150 the authority to pay bills no greater than $500, but a recent credit card bill after the holiday shopping season is now $550. The user profiles may include one or more tolerances pertaining to the one or more of the criteria in the rule set. For example, a user preference may indicate a breach of the $500 limit during the first three months of the year for up to a tolerance of an additional $50, or a user preference may indicate a breach of the $5,000 limit during the beginning of a fall or spring semester according to a college schedule for up to a tolerance of an additional $5,000 (e.g., a grandparent may have committed to assist the payment of a college tuition for a grandchild). Such tolerances and the associated criteria can be presented to the designated entity responsible for providing the necessary attestation when the attestation request is presented to the designated entity.

In one example, DB(s) 106 and/or 118 may store one or more proxy initiated transaction detection models (e.g., machine learning models (MLMs)) for detecting a proxy initiated transaction in communication sessions. Depending upon the type communication session and the permitted content types (e.g., audio only, video (with audio), AR/VR, multimedia, etc.), the proxy initiated transaction detection models may have different predictors/inputs. For instance, in one example, the proxy initiated transaction detection models may be trained for and deployed to detect various proxy initiated transactions in audio and/or text, e.g., monitoring machine to machine transactions, monitoring transactions of a minor or an elderly, and so on. In one example, the proxy initiated transaction detection models may further be trained for and may utilize images/video or other data as auxiliary inputs/predictors.

In one example, the proxy initiated transaction detection model(s) may comprise one or more machine learning algorithms (MLAs) and/or trained MLAs, e.g., MLMs. It should be noted that as referred to herein, a machine learning model (MLM) (or machine learning-based model) may comprise a machine learning algorithm (MLA) that has been “trained” or configured in accordance with input training data to perform a particular service (e.g., prediction, detection, classification, etc.). For instance, an MLM may comprise a deep learning neural network, or deep neural network (DNN), a convolutional neural network (CNN), a generative adversarial network (GAN), a decision tree algorithm/model, such as gradient boosted decision tree (GBDT) (e.g., XGBoost, XGBR, or the like), a support vector machine (SVM), e.g., a non-binary, or multi-class classifier, a linear or non-linear classifier, k-means clustering and/or k-nearest neighbor (KNN) predictive models, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented as topic detection models in examples of the present disclosure.

In one example, a proxy initiated transaction may comprise a purchase of an item, a sale of an item, a subscription to a service, a termination of a service, a financial transaction, a posting of a text comment on a social media website, a posting of an image on a social media website, a posting of an audio and/or video on a social media website, and so on. In one example, the present disclosure may utilize a lexicon that is specific to a subject area to determine various transactions present in communication sessions. For instance, a first lexicon may be used for transactions related to the broad theme of “sports,” a second lexicon may be used for transactions related to the broad theme of “cars/vehicles,” a third lexicon may be utilized for transactions related to the broad theme of “politics,” and so forth. Thus, the present disclosure may function with any lexicon that is presently available or that is later developed. In one example, the lexicon(s) may include transaction models, or transaction detection models (e.g., classifiers) for a number of products and/or services.

Notably, classifiers can be trained from any audio, text, and/or other types of content to recognize various topics, which may include “stock price,” “holiday sales,” “audit,” “math,” “physics,” “baseball,” “medieval literature,” “trip itinerary,” etc. Transaction identification classifiers may include support vector machine (SVM) based or non-SVM based classifiers, such as neural network based classifiers. The classifiers may be trained upon and utilize various data points to recognize transactions or other semantic content in text or audio. For instance, classifiers may utilize speech recognition/audio-to-text pre-processing to obtain a text transcript and to rely upon various keywords or phrases as data points, may utilize text recognition pre-processing to identify keywords or phrases in captioned text as data points, may extract and use audio features from one or more representative audio samples, such as low-level audio features, including: spectral centroid, spectral roll-off, signal energy, mel-frequency cepstrum coefficients (MFCCs), linear predictor coefficients (LPC), line spectral frequency (LSF) coefficients, loudness coefficients, sharpness of loudness coefficients, spread of loudness coefficients, octave band signal intensities, and so forth, wherein the output of the model in response to a given input set of audio features is a prediction of whether a particular semantic content is or is not present. For instance, in one example, each audio model may comprise a feature vector representative of a particular sound, or a sequence of sounds related to a transaction.

Similarly, classifier models may use low-level invariant image data, such as colors, shapes, color moments, color histograms, edge distribution histograms, etc., or may utilize image salience to detect objects in images, e.g., a picture of a baseball player wearing a particular baseball glove or baseball jersey. For instance, a quantized vector, or a set of quantized vectors representing a product, e.g., in one or more images and/or audio may be encoded using techniques such as principal component analysis (PCA), partial least squares (PLS), sparse coding, vector quantization (VQ), deep neural network encoding, and so forth. Thus, in one example, AS 104 may employ a feature matching detection. For instance, in one example, AS 104 may obtain new content and may calculate the Euclidean distance, Mahalanobis distance measure, or the like between a quantized vector of the image or audio data in the content and the feature vector(s) of the detection model(s) to determine if there is a best match (e.g., the shortest distance) or a match over a threshold value. In one example, different classifiers may be trained and may be deployed that may detect the same theme, but within different types of inputs (e.g., text or audio). In one example, a classifier may have multi-modal inputs, e.g., audio features plus a text transcript may comprise predictors to a single multi-modal classifier.

In one example, server(s) 104 or 116 may also ascertain the purpose of the proxy initiated transaction, e.g., holiday shopping, bill paying, social media posting, medical appointment scheduling, travel route discovery, etc. In one example, server(s) 104 or 116 may select to activate one or more detection models corresponding to the identified purpose. Alternatively, or in addition, server(s) 104 or 116 may initially operate a plurality of detection models to identify the primary purpose during the start of the network-based communication session, e.g., user endpoint device 110 interacting with a website hosted on server 116. In either case, when the purpose is identified, server(s) 104 or 116 may then monitor the audio content, text content, and/or instructions issued by one or more of the users 180-184 (or for all of the users). For instance, as noted above, audio features and/or text content may be used as inputs to one or more proxy initiated transaction detection models to detect that the relevant purpose of the interaction, or the details of the specific proxy initiated transaction.

It should again be noted that any number of server(s) 116 or database(s) 118 may be deployed in the system 100. In one example, network 102 is illustrated as including an application server (AS) 104 and a database (DB) 106. In one example, AS 104 may perform the same or similar functions as server(s) 116. Similarly, DB 106 may store the same or similar information as DB(s) 118 (e.g., a user profile database, a proxy initiated transaction detection model database/repository, etc.). For instance, network 102 may provide a proxy application monitoring and alerting service to subscribers (e.g., users). In one example, AS 104, DB 106, server(s) 116, DB(s) 118, and/or any one or more of the devices 110-114, may operate in a distributed and/or coordinated manner to perform various steps, functions, and/or operations described herein.

Similarly, it should again be noted that some or all of the functions described above in connection with server(s) 116 may alternatively or additionally be deployed in a user endpoint device or app thereof. For instance, a proxy initiated transaction monitoring application that operates in conjunction with a proxy application may monitor proxy initiated transactions of a user endpoint device to detect when a proxy initiated transaction requires an attestation from a designated entity.

It should be further noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. Similarly, although only two access networks 120 and 122 are shown, in other examples, access networks 120 and/or 122 may each comprise a plurality of different access networks that may interface with network 102 independently or in a chained manner. For example, device 113, device 114, and/or server(s) 116 may be in communication with network 102 via different access networks, and so forth. Thus, these and other modifications are all contemplated within the scope of the present disclosure.

To further aid in understanding the present disclosure, FIG. 2 illustrates an example user interface 200 of an attestation application, in accordance with the present disclosure. For instance, the user interface 200 may present an attestation request on an endpoint device of a designated entity who is tasked or designated to provide an attestation (positive or negative) for a proxy initiated transaction on behalf of a user (broadly a monitored user). In the present view, an image/video/avatar of a monitored user 210 may be presented in a larger representation in the user interface 200, while a smaller inset showing an image/video (or avatar, etc.) of other users 215-217 may be as shown in the interface screen. In the present example, a proxy initiated transaction of user 210 may be detected by a network-based application server, e.g., AS 104 in communication network 102, an endpoint device 110 and/or a third party application server 116, or the like, in response to which the proxy initiated transaction of user 210 may be automatically interrupted or paused (pending the receipt of a positive attestation from a designated entity before the proxy initiated transaction can be completed). In one embodiment, the attestation request shows an image (e.g., a photograph or an avatar) of the monitored user 210 along with the rule set 270 (to be used in the analysis to provide the attestation) applicable to the user 210, the proxy initiated transaction 275 requiring the attestation, and the attestation signature 278 that is expected for this attestation request. In one embodiment as shown in FIG. 2, the attestation request may also include the “expected” attestation signature that will be accepted, e.g., either a “thumbs up” gesture or symbol or a “thumb down” gesture or symbol in this illustrative example. The “expected” attestation signature or gesture can be conveyed to the designated entity along with the attestation request or the designated entity's endpoint device is already preconfigured to know which attestation signature or gesture will be accepted for each pertinent monitored user. This added security feature may enhance the authenticity of the attestation response. For example, a malicious actor may take control of a user endpoint device and causes the proxy application on the user endpoint device to carry out proxy initiated transactions to the detriment of the user who is being monitored. However, the malicious actor may not be aware of the “expected” attestation signature or gesture that will allow the proxy initiated transactions to be confirmed. In other words, even if the malicious actor is able to trigger the proxy initiated transactions and then intercept the attestation requests as well, the malicious actor may still not be able to ascertain the proper “expected” attestation signature or gesture that AS 106 or 116 is expecting for this monitored user in order for the proxy initiated transactions to be allowed to be carried out. The “expected” attestation signature or gesture can be sent by the proxy application randomly for each proxy initiated transaction or the “expected” attestation signature or gesture can be provided to the designated entity's endpoint device when the present proxy initiated transaction monitoring and alerting service was initially setup.

In one embodiment, the designated endpoint device of the designated entity may have an imaging device, e.g., a camera that can be trained onto the user of the designated endpoint device. The camera will be able to obtain the designated entity's gestures, e.g., a thumbs-up, a thumbs-down, a smile, a frown, and so on that can be used as the attestation response (e.g., correlated to either a positive attestation or a negative attestation).

In addition to presenting the attestation request to the designated entity for the user 210, the user interface 200 may include a notification area, which may include a plurality of possible attestation signatures 250 that can be used to respond to an attestation request. The notification area may also include a meter or a visual scale 260 indicating a degree to which the proxy initiated transaction of the user 210 should receive a positive vouching (positive attestation) or a negative vouching (negative attestation). Namely, as discussed above, a rule set 270 may be applicable to the user 210 for this proxy initiated transaction, but the criteria of the rule set 270 may be fairly complicated so that the application presenting the interface 200 may attempt to apply the rule set 270 to the detected parameters of this proxy initiated transaction to assist the designated entity to quickly ascertain whether to vouch or not vouch for the proxy initiated transaction. Since certain transaction scenarios may not be very clear as to whether the attestation should be positive or negative, the meter or visual scale 260 may indicate a relative degree to which the attestation may lean toward (positive or negative).

In addition to presenting the attestation request to the designated entity for the current user 210, in one embodiment the user interface 200 may include a historical area that shows a plurality of monitored users 215-217, their purchases 220, their banking transactions 230, their social media postings 240, and the designated entity's decision as to providing a positive attestation or a negative attestation (e.g., using a strike-thru symbol Ø for a negative attestation and no symbol for a positive attestation) for each of the proxy initiated transaction for each of the monitored users. The historical area also shows the necessary expected attestation signature or gesture for each monitored user.

It should be noted that FIG. 2 and the above description represent just one example of a user interface 200 that may be implemented in accordance with the present disclosure. Thus, other, further, and different examples may have more or less features, or different features from that which is illustrated in FIG. 2. For instance, in another example, the interface 200 may also show if an “automated” attestation response was generated and provided for a proxy initiated transaction, e.g., a symbol such as red flag is shown next to user 216 attempting to purchase a controlled substance or user 217 attempting to purchase a car as shown FIG. 2. Such symbols will indicate to the designated entity that machine to machine communication/transaction was conducted for those attestation requests.

FIG. 3 illustrates a flowchart of an example method 300 for providing an attestation for a transaction performed by a proxy application. In one example, the method 300 is performed by a component of the system 100 of FIG. 1, such as by one of the servers 116, application server 104, and/or any one or more components thereof (e.g., a processor, or processors, performing operations stored in and loaded from a memory), or by one of the servers 116 or application server 104, in conjunction with one or more other devices, such as DB 106, DB 118, any one or more of devices 110-114, and so forth. In another example, the method 300 may be performed by an endpoint device, such as one of the devices 110-114 of FIG. 1, or one of the devices 110-114 in conjunction with one or more other devices or systems, such as a different one of the devices 110-114, server(s) 116, AS 104, etc. In one example, the steps, functions, or operations of method 300 may be performed by a computing device or system 400, and/or processor 402 as described in connection with FIG. 4 below. For instance, the computing device or system 400 may represent any one or more components of a server 116, an application server 104, one of the endpoint devices 110-114, etc. in FIG. 1 that is/are configured to perform the steps, functions and/or operations of the method 300. Similarly, in one example, the steps, functions, or operations of method 300 may be performed by a processing system comprising one or more computing devices collectively configured to perform various steps, functions, and/or operations of the method 300. For instance, multiple instances of the computing device or processing system 400 may collectively function as a processing system. For illustrative purposes, the method 300 is described in greater detail below in connection with an example performed by a processing system. The method 300 begins in step 305 and may proceed to optional step 310 or to step 320.

At optional step 310, the processing system may train one or more transaction detection models and/or one or more proxy attestation models, e.g., where the one or more transaction detection models comprise at least one machine learning model that is trained to detect or distinguish a transaction as either: a proxy initiated transaction or a human initiated transaction. For instance, the transaction detection models may comprise machine learning models (MLMs) trained in accordance with a training data set comprising a plurality of proxy initiated transactions, where each of the plurality of proxy initiated transactions is labeled with at least one type of transaction including whether the transaction is proxy initiated or human initiated. Alternatively, or in addition, the MLM(s) may be trained with text-format training data (which in one example may comprise text that is generated from audio samples of a user instructing the proxy application to perform the proxy initiated transaction via a speech-to-text conversion process). In other words, at least one of the MLMs/detection models may be trained on the user's audio instruction directly, or a combination of the user's audio instruction and the one or more tasks executed in the proxy initiated transaction. For instance, the tonality and/or other non-semantic audio features can help to indicate the transaction that the user is asking the proxy application to be performed. However, another MLM may be trained on converted text samples, while non-semantic audio features may be omitted (and/or used as inputs for a different MLM to detect the user's transactional intent, or the like, which may subsequently be used as an input to a transaction detection model and/or an AI/ML layer). Additionally, for instance, the proxy attestation models may comprise machine learning models (MLMs) trained in accordance with a training data set comprising a plurality of proxy initiated transactions that require attestations to be provided by a designated entity, where each of the plurality of proxy initiated transactions is labeled with at least one type of transaction.

In one example, the training data set may further comprise a plurality of visual samples associated with the user's audio samples, where each of the plurality of visual samples (e.g., pictures of potential gift items to be purchased, pictures to be posted on a social media website, and so on) may be labeled with a respective user's transactional intent. For instance, the at least one MLM may comprise at least two MLMs, where a first MLM may be trained to detect user transactional intent from input visual samples, and wherein the user transactional intent may comprise an auxiliary input to at least a second MLM that is trained to detect proxy attestation requirement(s) or the necessity for obtaining an attestation from a designated entity (e.g., the proxy initiated transaction requiring attestation identified at step 330).

At step 320, the processing system establishes a communication session between at least a first endpoint device of a first user and at least one third party application server via at least one network. For instance, as noted above, the processing system may comprise one of: a network-based processing system that establishes and monitors the communication session, a network-based third party processing system (e.g., server 116) that is different from a hosting system (e.g., server 104) of the communication network, or the first endpoint device of the first user (e.g., an endpoint device of the first user may comprise a virtual assistant monitoring application distinct from the virtual assistant application, or the like that may perform steps of the method 300).

At step 330, the processing system detects at least one proxy initiated transaction for the communication session. For instance, in one example, the at least one proxy initiated transaction may be identified by the first user endpoint device, and/or one or more of the application server 104 and application server 116. Alternatively, or in addition, the at least one proxy initiated transaction may be determined via at least one transaction detection model. For instance, the processing system may initially operate one or more transaction detection models to identify the proxy initiated transaction during the start of the communication session. In one example, the one or more transaction detection models may comprise an MLM that may be trained by the processing system at step 310, or which may be otherwise obtained and implemented by the processing system.

At step 340, the processing system, responsive to the detected at least one proxy initiated transaction, forwards an attestation request to a designated entity associated with the first user endpoint device to obtain the necessary attestation in order to allow the at least one proxy initiated transaction to be completed. In one embodiment, the processing system may also apply a rule set to determine whether the detected at least one proxy initiated transaction requires the attestation from the designated entity. In other words, only those proxy initiated transactions deemed to require an attestation will trigger the forwarding of the attestation request to the designated entity. As noted above in connection with optional step 310, the at least one proxy attestation detection model may comprise at least one machine learning model (MLM) that is trained to detect at least one of proxy initiated transaction that requires an attestation from a designated entity. In one example, an output of the at least one MLM may comprise an indication of whether to send the attestation request to the designated entity or not. In addition, in one example, an output of the at least one MLM may further include a measure or a degree of the need for the attestation from the designated entity (e.g., an attestation is need, an attestation is not needed, an attestation is likely needed, an attestation is likely not needed etc.). For instance, the processing system may determine that a proxy initiated transaction involving the setup of a doctor appointment for a yearly physical examination does not require an attestation, but the processing system may determine that a proxy initiated transaction involving the setup of a medical scan, e.g., an X-ray scan, an ultrasound scan, a magnetic resonance imaging (MRI) or a computed tomography (CT) scan, may likely require an attestation. In this example, some medical scans such as an X-ray scan and an ultrasound scan may not require an attestation, whereas a magnetic resonance imaging (MRI) or a computed tomography (CT) scan will require an attestation. An objective measure as to how likely an attestation is required for a proxy initiated transaction can be used. For instance, the objective measure may be made in accordance with a language model, a distance metric using word/sentence/document embeddings (doc2vec, etc.), or the like.

In one example, step 340 may include providing a recommendation to the designated entity if the processing system has access to the rule set to be applied to the proxy initiated transaction for determining an appropriate attestation response (e.g., positive or negative). For example, the processing system may be a network based system where a monitoring and alerting service is provided to the first user of first endpoint device. However, if the processing system does not have access to the rule set to be applied to the proxy initiated transaction, then the processing system will simply forward the attestation request to the designated entity without any recommendation.

At step 350, the processing system receives an attestation from the designated entity (e.g., a positive attestation to proceed with the proxy initiated transaction or a negative attestation to not proceed with the proxy initiated transaction). In one embodiment, the lack of response from the designated entity may be interpreted as a negative attestation to not proceed with the proxy initiated transaction. However, in another embodiment, the lack of response from the designated entity may be interpreted as a positive attestation to proceed with the proxy initiated transaction. In other words, based on the implementation, a lack of response from the designated entity can be configured as a positive attestation or a negative attestation. Furthermore, the processing system may also provide a response time period to receive the attestation response. For example, the lack of response from the designated entity within the predefined response time period may be interpreted as a positive attestation to proceed with the proxy initiated transaction, or vice versa.

At optional step 360, the processing system sends the attestation from the designated entity (e.g., a positive attestation to proceed with the proxy initiated transaction or a negative attestation to not proceed with the proxy initiated transaction) to a third party application server via at least one communication network. In response, the third party application server may then allow the proxy initiated transaction to proceed to completion or to terminate the proxy initiated transaction before the proxy initiated transaction can be completed. For example, the processing system may be implemented on the application server 104 and the third party application server may be implemented as application server 116. Thus, application server 104 will send the attestation from the designated entity to the application server 116. However, alternatively, if the processing system is implemented on the first user endpoint device 110, then the attestation from the designated entity is simply processed locally to either allow the proxy application 150 to complete the proxy initiated transaction or to terminate the proxy initiated transaction. Following step 350 or optional step 360, the method 300 proceeds to step 395 where the method ends.

In one embodiment, one aspect of the present disclosure is that the attestation request is only generated and sent after the proxy initiated transaction has proceeded along just up to the point of completion, e.g., the point just before “hitting” the button to confirm a purchase of a product from a retailer, “hitting” the button to confirm a transfer of funds between accounts of a financial institution, “hitting” the button to confirm posting of a comment or an image to your social media wall of a social media service provider, and so on. Thus, unlike an account authentication application that requires the necessary authentication to initially access an account, the present disclosure does not intercede in the transaction until the proxy initiated transaction is just about to be concluded or completed. This aspect allows the present disclosure to allow the proxy application to freely perform its functions just up to the point where the attestation is required, thereby allowing the proxy application to execute freely without undue constraints.

It should be noted that the method 300 may be expanded to include additional steps, or may be modified to replace steps with different steps, to combine steps, to omit steps, to perform steps in a different order, and so forth. For instance, in one example the processor may repeat one or more steps of the method 300 on an ongoing basis as new proxy initiated transactions are received for other users. In another example, the method 300 may be expanded to include tracking the effectiveness of the attestation request generation and forwarding. For instance, in an example in which the processing system forwarded the attestation request for a particular proxy initiated transaction, the user or the designated entity may provide feedback, e.g., indicating whether the user or the designated entity finds the action(s) taken to be helpful or not helpful. In one example, the method 300 may include periodically retraining the one or more models (e.g., MLM(s)) of step 310. Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 4 depicts a high-level block diagram of a computing system 400 (e.g., a computing device or processing system) specifically programmed to perform the functions described herein. For example, any one or more components, devices, and/or systems illustrated in FIG. 1 or described in connection with FIGS. 2 and 3, may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where the hardware processor element 402 may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for providing an attestation for a transaction performed by a proxy application, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 402 is shown, the computing system 400 may employ a plurality of hardware processor elements. Furthermore, although only one computing device is shown in FIG. 4, if the method(s) as discussed above is implemented in a distributed or parallel manner for a particular illustrative example, e.g., the steps of the above method(s) or the entire method(s) are implemented across multiple or parallel computing devices, then the computing system 400 of FIG. 4 may represent each of those multiple or parallel computing devices. Furthermore, one or more hardware processor elements (e.g., hardware processor element 402) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 405 for providing an attestation for a transaction performed by a proxy application (e.g., a software program comprising computer-executable instructions) can be loaded into memory 404 and executed by hardware processor element 402 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 402) executing the computer-readable instructions relating to the above described method(s) can be perceived as a programmed processor or a specialized processor. As such, the present module 405 for providing an attestation for a transaction performed by a proxy application (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
establishing, by a processing system including at least one processor, a communication session between at least a first endpoint device of a first user and at least one third party application server via at least one communication network;
detecting, by the processing system, at least one proxy initiated transaction for the first endpoint device requiring an attestation;
forwarding, by the processing system, an attestation request to a designated entity responsive to the at least one proxy initiated transaction being detected; and
receiving, by the processing system, the attestation from the designated entity.

2. The method of claim 1, further comprising:
sending, by the processing system, the attestation received from the designated entity to the at least one third party application server via the at least one communication network.

3. The method of claim 2, wherein the at least one third party application server hosts at least one of: a website of a retailer, a website of a financial institution, or a website of a social media service provider.

4. The method of claim 1, wherein the detecting is performed via at least one transaction detection model.

5. The method of claim 4, wherein the at least one transaction detection model comprises at least one machine learning model that is trained to detect the at least one proxy initiated transaction from a human initiated transaction.

6. The method of claim 1, wherein the designated entity is the first user.

7. The method of claim 1, wherein the designated entity is another user distinct from the first user.

8. The method of claim 1, wherein the designated entity is another processing system distinct from the processing system.

9. The method of claim 8, wherein the attestation is received from the another processing system via a machine to machine communication without any human input.

10. The method of claim 1, wherein the at least one proxy initiated transaction is initiated by a proxy application located on the first endpoint device.

11. The method of claim 10, wherein the proxy application comprises a digital assistant application tasked with performing a transaction on behalf of the first user.

12. The method of claim 10, wherein the proxy application located on the first endpoint device interacts with at least one other application located on the first endpoint device via an application programming interface to effect the at least one proxy initiated transaction.

13. The method of claim 12, wherein the at least one other application comprises a browser application.

14. The method of claim 1, wherein the processing system comprises:
a network-based processing system that is deployed in the at least one communication network;
the at least one third party application server; or
the first endpoint device of the first user.

15. The method of claim 1, wherein the attestation comprises a positive attestation or a negative attestation.

16. The method of claim 15, wherein the positive attestation allows the at least one proxy initiated transaction to be carried out to completion.

17. The method of claim 15, wherein the negative attestation disallows the at least one proxy initiated transaction from being carried out to completion.

18. The method of claim 1, wherein the at least one proxy initiated transaction comprises one of: a transaction to purchase a product, a transaction to subscribe to a service, a transaction to conduct a banking transaction, or a transaction to make a posting on a social media website.

19. A non-transitory computer-readable medium storing instructions which, when executed by a processing system including at least one processor, cause the processing system to perform operations, the operations comprising:
establishing a communication session between at least a first endpoint device of a first user and at least one third party application server via at least one communication network;
detecting at least one proxy initiated transaction for the first endpoint device requiring an attestation;
forwarding an attestation request to a designated entity responsive to the at least one proxy initiated transaction being detected; and
receiving the attestation from the designated entity.

20. An apparatus comprising:
a processing system including at least one processor; and
a computer-readable medium storing instructions which, when executed by the processing system, cause the processing system to perform operations, the operations comprising:
establishing a communication session between at least a first endpoint device of a first user and at least one third party application server via at least one communication network;
detecting at least one proxy initiated transaction for the first endpoint device requiring an attestation;
forwarding an attestation request to a designated entity responsive to the at least one proxy initiated transaction being detected; and
receiving the attestation from the designated entity.
